(19) United States
(12) Patent Application Publication
(10) Pub. No.: US 2016/0136652 A1
(43) Pub. Date: May 19, 2016

(54) Bulk Material Shredder

(71) Applicant: Wael A. Alharbi, Denver, CO (US)

(72) Inventor: Wael A. Alharbi, Denver, CO (US)

(21) Appl. No.: 14/541,468

(22) Filed: Nov. 14, 2014

(51) Int. Cl. B02C 18/22; B08B 7/04; B08B 5/04; B02C 23/24; B02C 21/02

(52) U.S. Cl. CPC B02C 18/2216; B02C 23/24; B02C 21/02; B08B 5/04; B08B 7/04; B02C 2018/168

(57) ABSTRACT

A shredder is particularly usefull to shred away a hardened block of plastic that has formed in a polymer reactor. One or more motors are mounted on a shroud that is controlled with a handle guide similar to a floor polisher. The motor (s) powers a helical milling cutter that drills down through the plastic and is then moved around to repeatedly shred off the plastic. A vacuum system removes the debris to outside the reactor. A coolant system can help cool the blades.

### FIELD OF INVENTION

The present invention relates to providing a shredding machine used to remove a hardened bulk material such as a polymer which hardens and blocks a polymer reactor.

### BACKGROUND OF THE INVENTION

A gas fluidized bed reactor (aka, polymerization reactor) is a device in which substances are made to react chemically. The simple description of the polymerization process is that metallic catalyst particles and the polymer matrix (fed from the top of the reactor) react with the flow of hydrocarbon gas (monomer) which is pumped from the bottom of the reactor to the top. During the polymerization process an, undesired temperature gradient may take place causing a local hot spot. As a result, polymer particles melt and become a one piece block or chunk perhaps five meters wide and three meters deep. The prior art removal of this chunk requires several worker to man hand held pneumatic chain saws to cut large blocks of the chunk. Then, the blocks are hoisted up and out of the reactor. Another method is to use high pressure water-jets. These removal processes in the confined hot quarters are dangerous and time consuming. Many injuries and deaths are reported mainly due to fatigue or chain saw kickback that caused an operator to cut his coworker. The clearing process may take several weeks to be accomplished.

Related prior art includes U.S. Pat. No. 8,684,796 (2014) to McCutchen et al. This grinding and polishing machine is controlled by a handle and has a shroud covering a pair of rotating spindles which can secure a grit material for grinding or polishing. Electric motors power the spindles. The dust is carried away by a vacuum hose. U.S. Pat. No. 8,485,287 (2013) to Sewell discloses in FIG. 2 a trencher tool carried by a ride on work vehicle. An on board gas engine powers the vehicle.

What is needed in the art is a safe and efficient shredding machine that can be manually maneuvered like a floor polisher. Thus, the cutting blades should be shielded by a housing that has handles for the worker to control. The present invention provides a pneumatic (or electric or diesel) shredder that rides across the hardened floor to be removed.

### SUMMARY OF THE INVENTION

The main aspect of the present invention is to provide a shredding machine wherein a housing shields the spinning cutters and the weight of the shroud and a pneumatic motor helps stabilize the machine flat against the floor to keep the operator safe. An equivalent motor could be an explosion proof electric motor or a diesel engine which would be heavier.

Another aspect of the present invention is to provide at least one pneumatic motor that powers a helical cutter connected to a vertical drive shaft.

Another aspect of the present invention is to provide an air (or nitrogen or water coolant stream to the cutter.

Another aspect of the present invention is to provide a vacuum hose to the housing to remove the plastic shards as they are cut from the floor.

Another aspect of the present invention is to provide alternate systems that have a plurality of cutter motors mounted on a single housing.

Other aspects of this invention will appear from the following description and appended claims, reference being made to the accompanying drawings forming a part of this specification wherein like reference characters designate corresponding parts in the several views.

The basic unit has a single air driven motor of perhaps 25 horsepower. A linkage from the motor turns a helical milling cutter of the type used on computer controlled milling machines (or computer numerical controlled (CNC) machine). This cutter has coolant air piped to the blades to help keep the shredded particles from melting together, to cool the blades and to keep the shredded particles from the cutting zone. The shredded particles are guided to a vacuum exhaust port. A vacuum tube is fed from an opening above the operator to a preferably truck mounted vacuum system. Preferably this truck also carries the compressor for the drive motor.

Other embodiments use multiple motors or a single motor using a transmission to power two counter—rotating helical milling cutters. The cutter could be of a type similar to Seco Model number R220.69-18, and the drive collar could be of a type similar to a Stafford part no. 5EL614.

### BRIEF DESCRIPTION OF THE DRAWINGS

FIG. 1 (prior art) is a front cutaway view of a blocked polymer reactor undergoing a traditional clean-out.

FIG. 2 is a front cutaway view of a blocked polymer reactor being cleaned out by two single motor shredders.

FIG. 3 is front elevation cutaway view of the polymer reactor in FIG. 2 including the support equipment on the ground.

FIG. 4 is a rear perspective view of the shredder shown in FIG. 2.

FIG. 5 is a cross sectional view taken along line A-A of FIG. 2.

FIG. 6 is a front perspective view of the milling cutter and the shaft adapter.

FIG. 7 is a cross sectional exploded view of the milling cutter and the shaft adapter taken along line B-B of FIG. 2.

FIG. 8 is a cross sectional view of the milling cutter and the shaft adapter taken along line B-B of FIG. 2.

FIG. 9 is a top plan view of a shredder having two motors.

FIG. 10 is a bottom plan view of a shredder having one motor and a transmission driving two milling cutters.

FIG. 11A is a cutaway view of a blockage with a flat top surface.

FIG. 11B is the same view as FIG. 11A with a blockage having a slightly tilted top surface.

FIG. 11C is the same as FIG. 11A with a blockage having a heavily tilted top surface, wherein the shredder requires a hoist for safe operation.

FIG. 11D is the same view as FIG. 11C with the shredder making the top surface less tilted.

FIG. 12 is a top plan view of a four motor two operator shredder.

Before explaining the disclosed embodiment of the present invention in detail, it is to be understood that the invention is not limited in its application to the details of the particular arrangement shown, since the invention is capable of other embodiments especially for other bulk materials. Also, the terminology used herein is for the purpose of description and not of limitation.

### DETAILED DESCRIPTION OF THE DRAWINGS

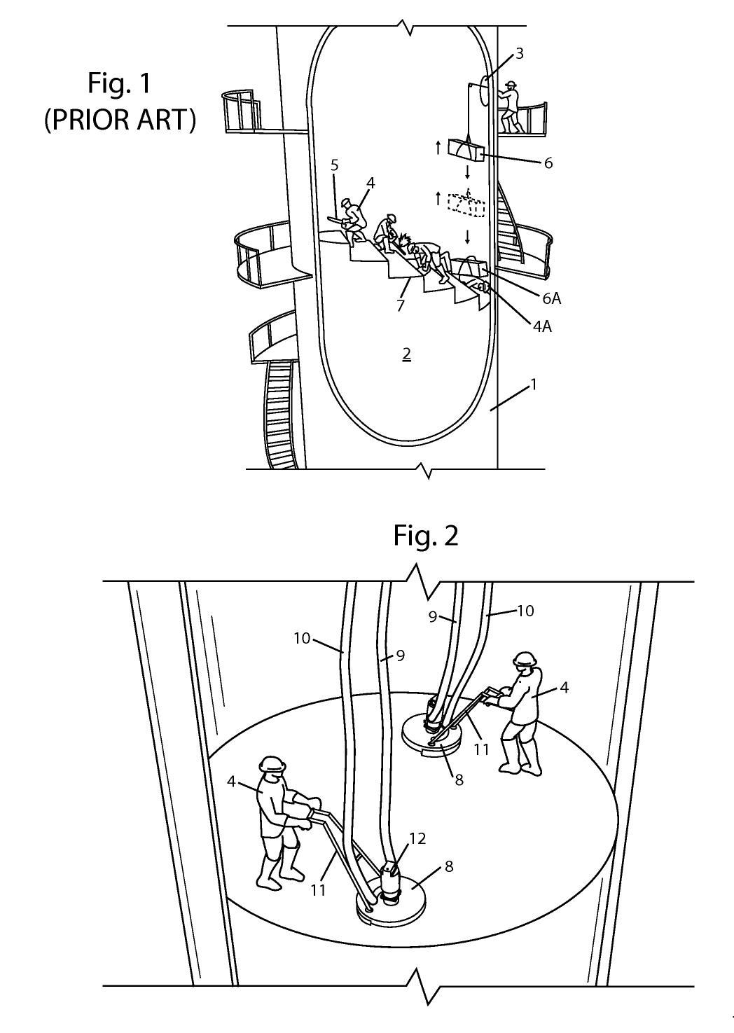

Referring first to FIG. 1 a polymer reactor 1 has become blocked by the hardening of the polymer beads forming a block 2. Above the block 2 is an entrance 3 into the reactor 1. Workers 4 using pneumatic chain saws 5 have cut out large blocks 6 to form steps 7. The blocks 6 are hoisted up and out of entrance 3. Block 6A has fallen and injured worker 4A. Other hazards include accidental cutting of a worker with a chain saw in closed, hot dark quarters. This type operation could take a month to remove block 2.

Referring next to FIG. 2 the same block 2 is being removed using shredders 8. Workers 4 control the shredder 8 using handle guides 11. A motor (pneumatic shown) 12 is powered by hose 9 from an external compressor. A vacuum removal hose 10 removes the debris using an external vacuum system.

A proof of concept experiment was done on a standard CNC machine. The shredding results at room temperature follow below:
CNC machine: Haas DS-30 (30 hp)
Cutter: helical cutting tool
Temperature: Room temperature
Diameter of cutter: 1.5 in
Height of cutter: 1.86 in
RPM: 4500
Feed rate=126 in/min
Speed=1767 surface foot per minute (SFM)
% of average hp power used=70%
Material Removal Rate (MRR)=352 in̂3/min
Dimension of block tested=18*18*2 in̂3
Material of the block=High Density Polyethylene (HDPE)

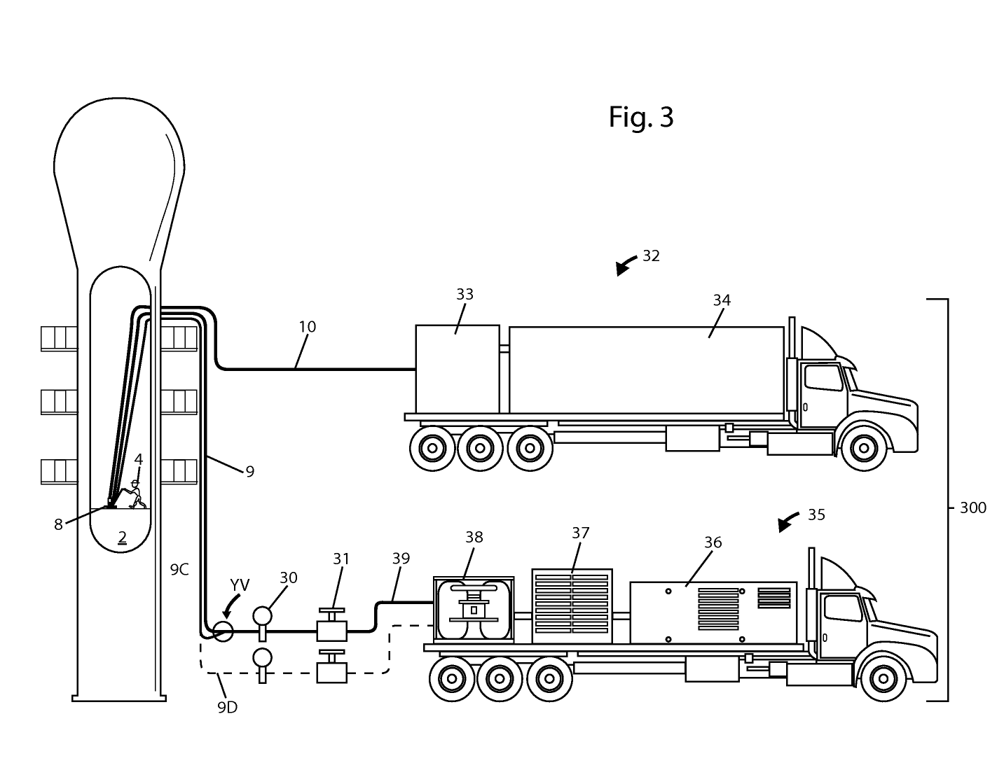

Referring next to FIG. 3 a transportable pneumatic system is numbered 300. The vacuum system 32 includes vacuum hose 10 which is powered by vacuum 33 which ejects the debris into container 34.

This embodiment of the power system 35 has a compressor 36 feeding high pressure air into an after cooler 37 then a drier 38. A single outlet hose 39 has a pressure regulator 31 and pressure gauge 30. A Y assembly YV splits the hose 39 into a power branch 9 and an air coolant branch 9C. Design choice could place the Y assembly YV at the shredder 8. Another choice (labeled 9D) could be to pipe coolant air directly from the dryer 38. Also not shown is a liquid cooling arrangement equivalent with a separate liquid flow system.

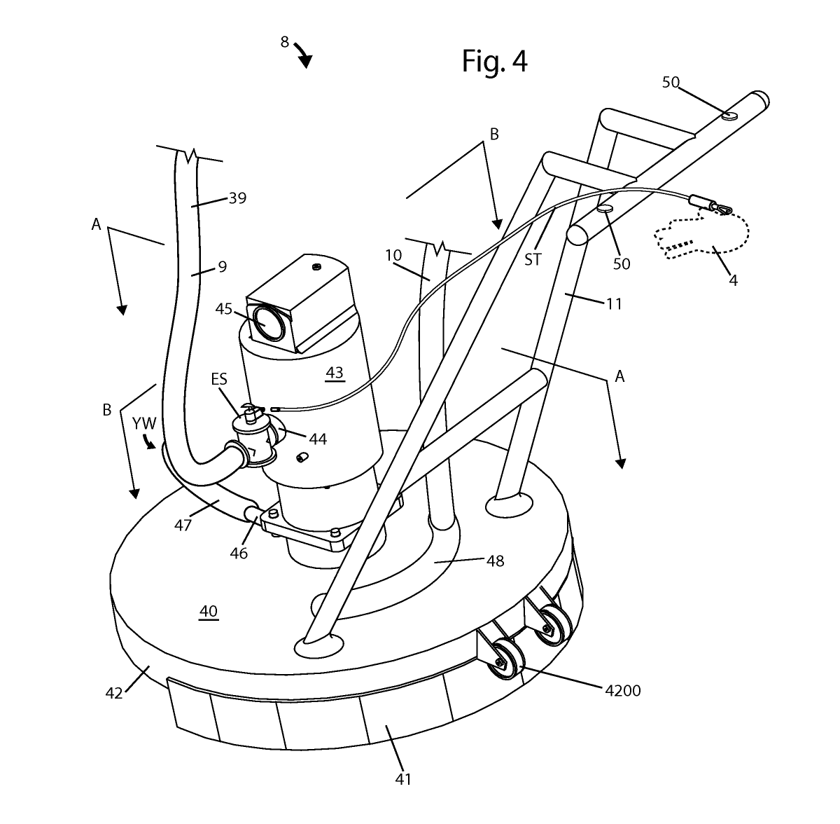

Referring next to FIG. 4 the shredder 8 has a shroud 40 with a rear curtain 41 to keep debris under the shroud's peripheral wall 42. Travel wheels 4200 allow rolling the shredder 8 for transport.

Motor 43 has power inlet 44 and air exhaust port 45. A coolant port 46 is fed by hose 47. This embodiment has the Y assembly YV adjacent the shredder 8. A pressure regulator assembly inside the Y assembly YV maintains the proper air pressure for the motor 43 and the coolant port 46.

The vacuum hose 10 draws debris trapped by a concave recess 48 under the top of the shroud 40 and the curtain 41. A safety tether ST attaches to the worker 4 at his wrist so that a pull on tether ST shuts off the power air at emergency shutoff ES which could be an explosion proof solenoid valve. Other safety features may include dual “ON” buttons which could use an explosion proof battery powered switch to activate emergency shutoff ES. Both buttons 50 would need to be depressed to operate shredder 8.

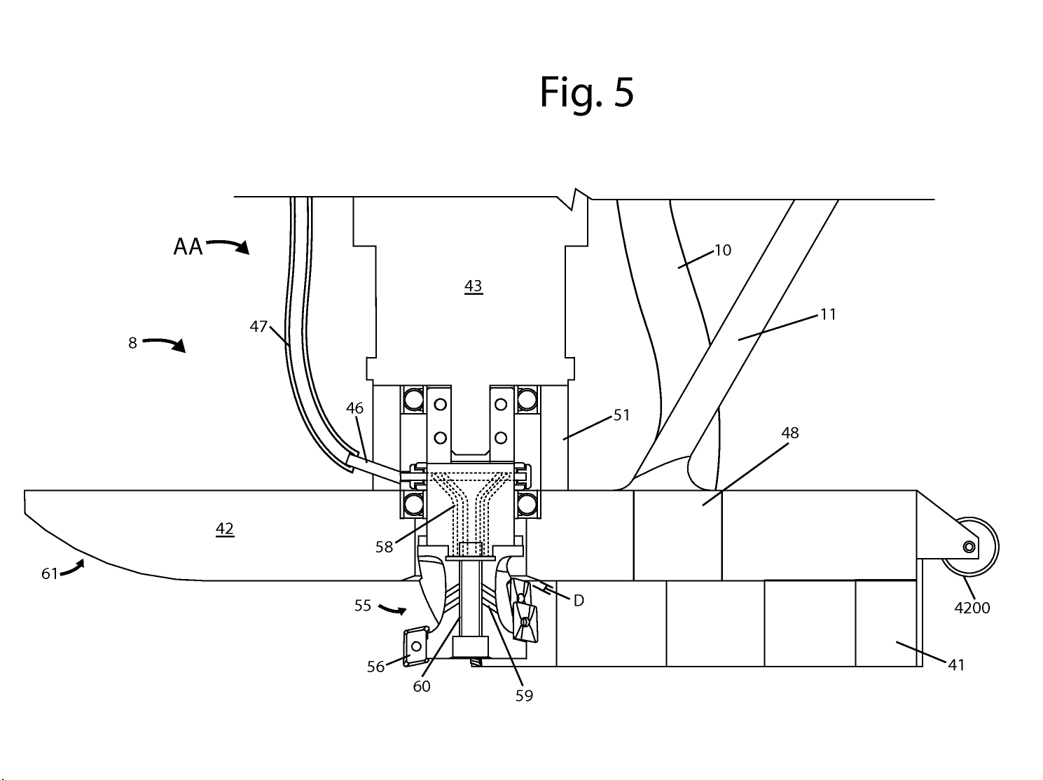

Referring next to FIG. 5 the motor 43 drives a shaft adapter 57. The shaft adapter receives coolant air from port 46 and sends this air down channels 58 to a hollow center 60 of milling cutter 55. This coolant air then flows out cooling channels 59 towards the blades 56. The leading edge 61 of shroud 40 is included to ride along the block 2.

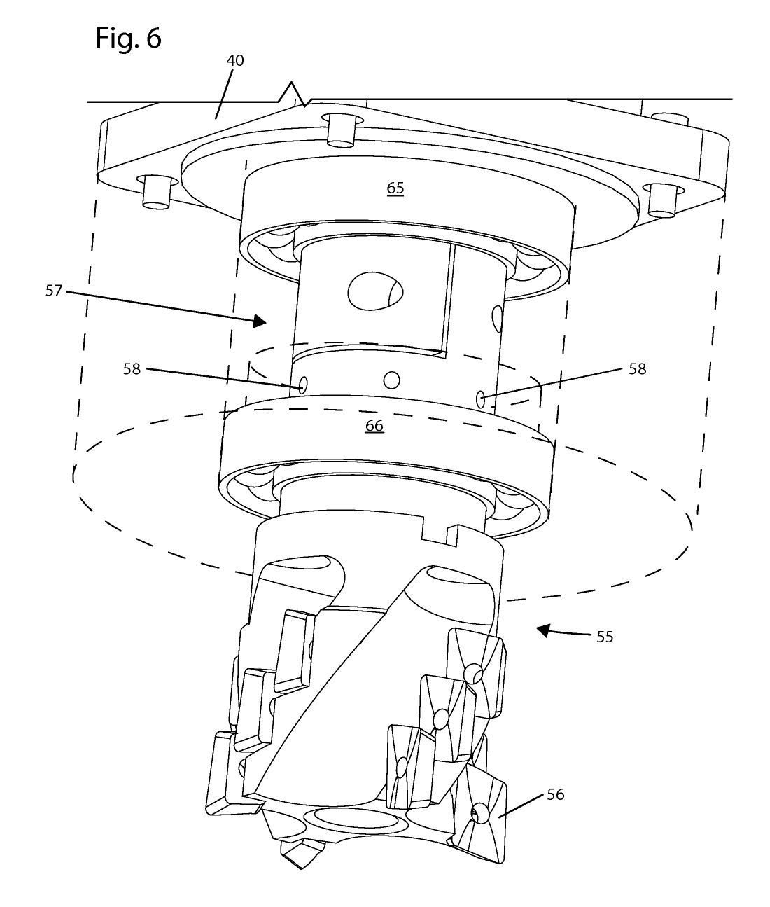

Referring next to FIG. 6 the shaft adapter 57 may be secured by an upper bearing 65 and a lower bearing 66.

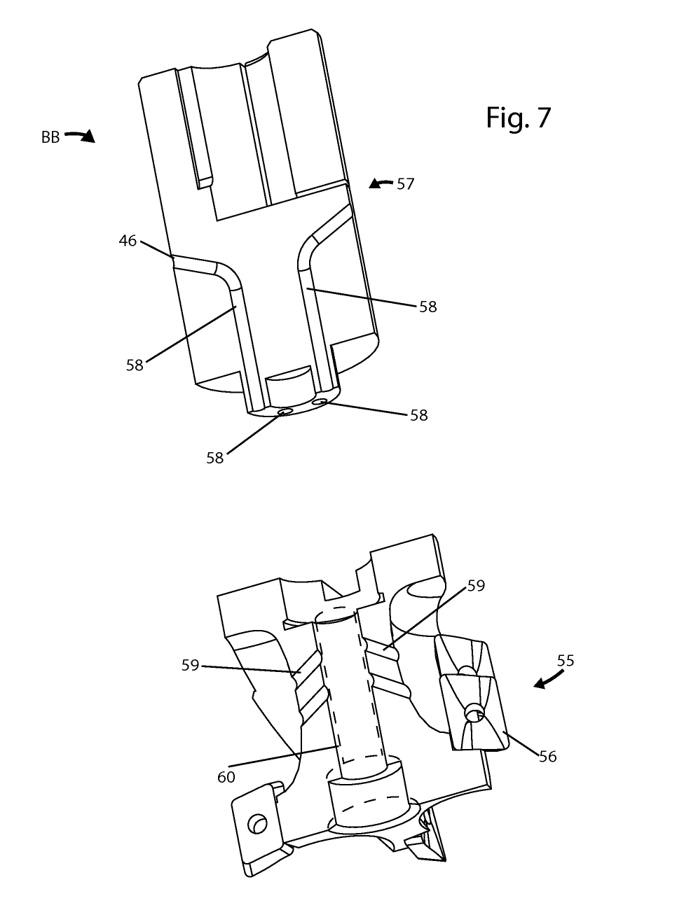

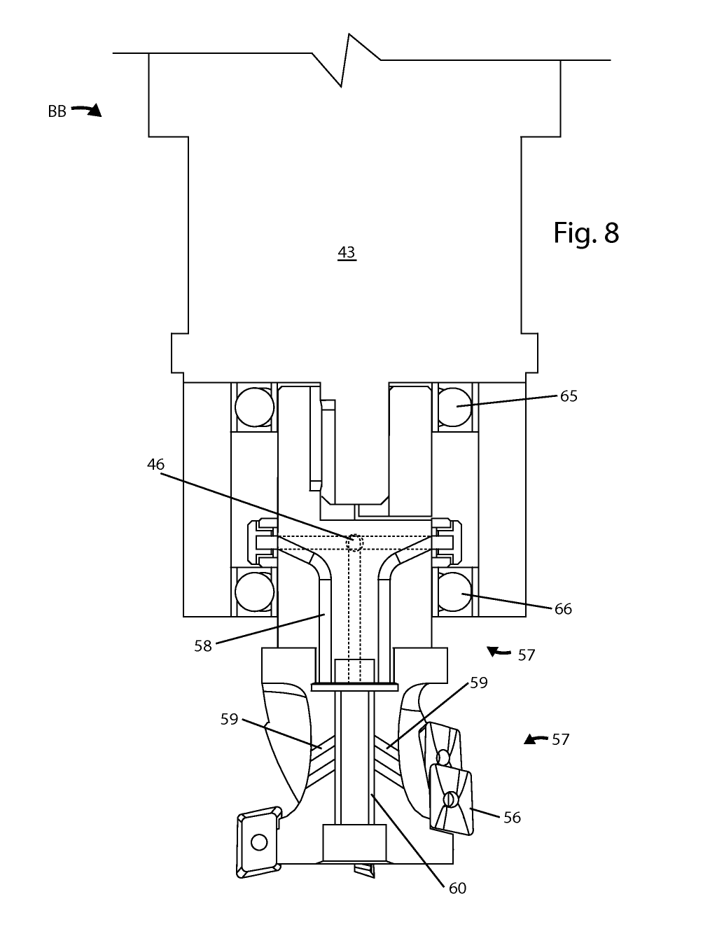

In FIGS. 7, 8 the coolant air travels from port 46 through channels 58 in shaft adapter 57 then into hollow 60 of milling cutter 55 and finally out channels 59 toward blades 56.

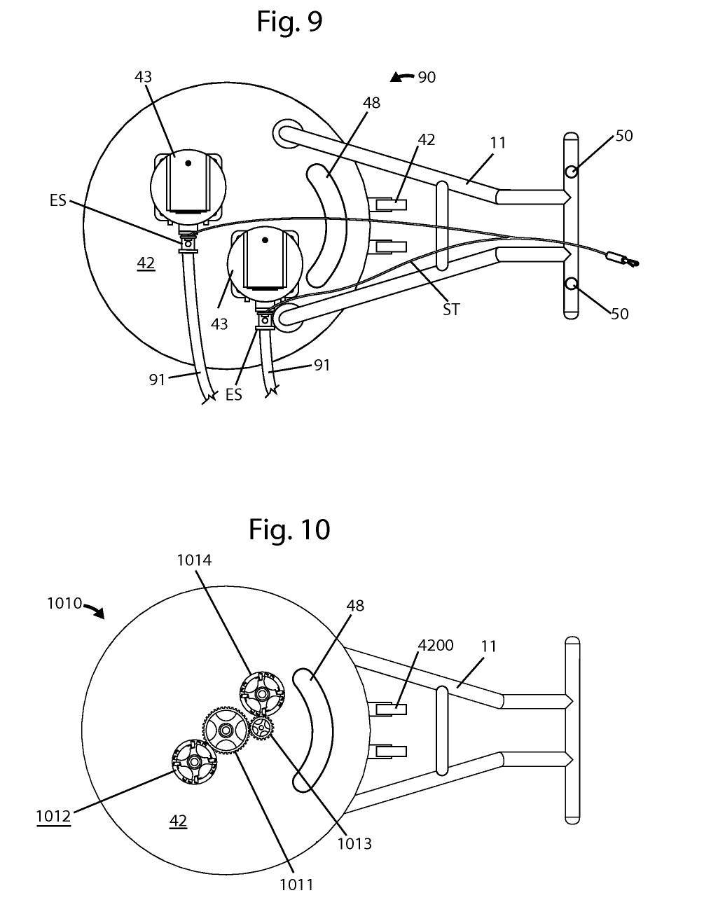

Referring next to FIG. 9 a shredder 90 has two motors 43. This embodiment shows two separate air power hoses, each with a safety kill switch ES. However, a Y assembly (not shown) could have a single kill switch to cut the air to each of two power hoses.

Referring next to FIG. 10 a shredder 1010 has the motor drive gear 1011 driving a first milling cutter drive gear 1012 clockwise. Then idler gear 1013 reverse the spin of the second milling cutter drive gear 1014 to counterclockwise.

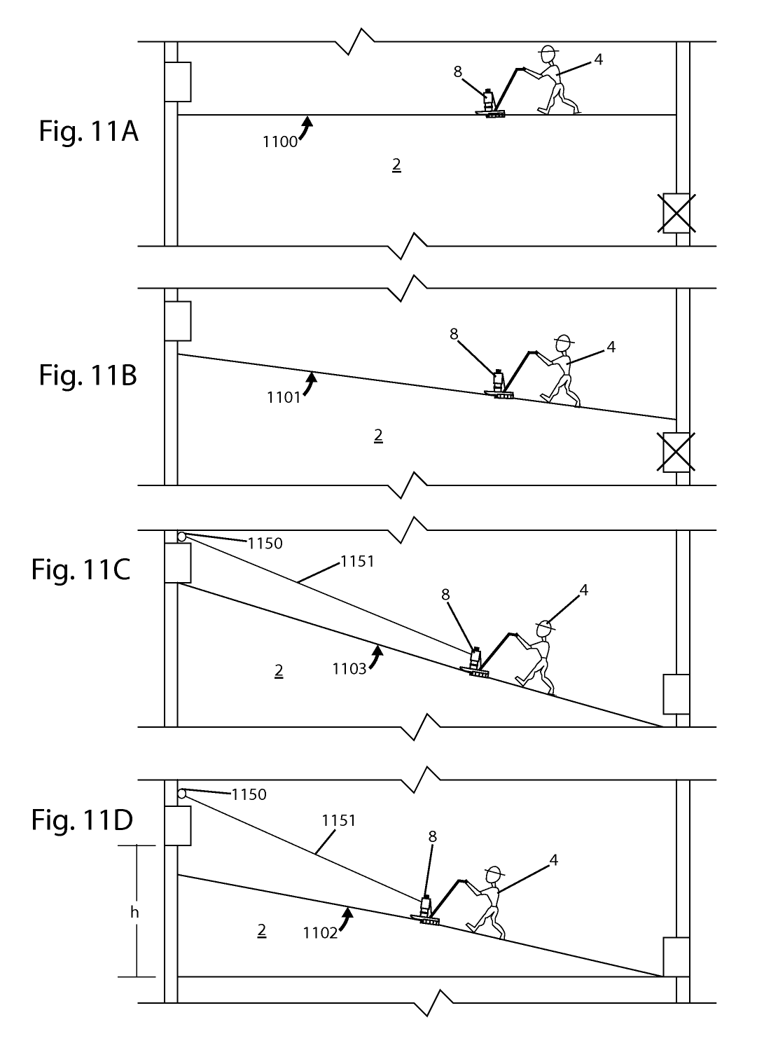

In FIG. 11A the block 2 has flat top surface 1100. In FIG. 11B the top surface 1101 has a slight tilt, but the shredder 8 can still be handled by one operator 4.

However, in FIG. 11C the top surface 1102 is too steep for shredder 8 to be handled. So a hoist assembly 1150 is controlled to keep tether 1151 taught and lifting or lowering shredder 8 as operator 4 requires. In FIG. 11D top surface 1103 has gradually been reduced in steepness and will soon be flat enough to remove tether 1151.

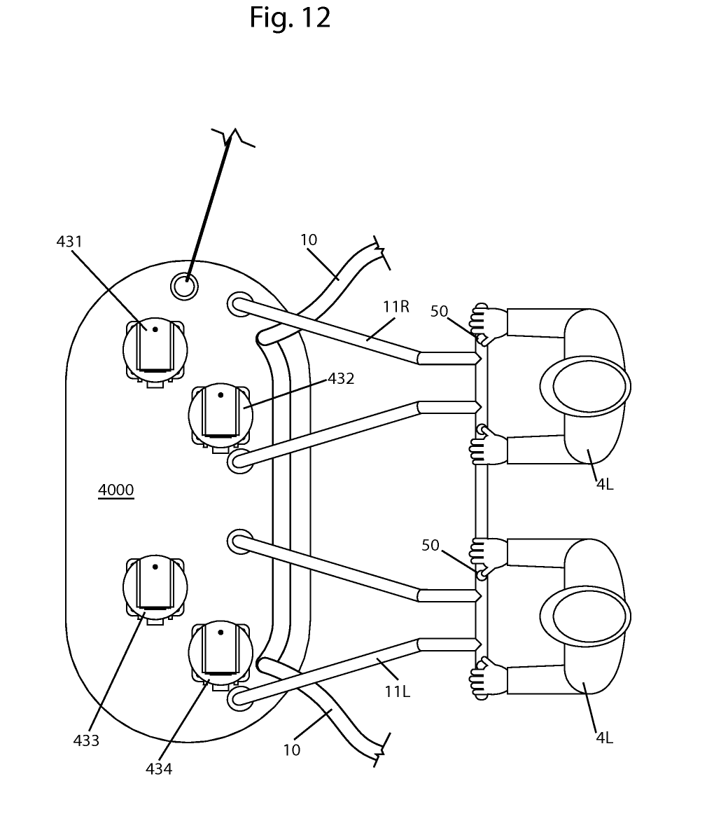

Referring next to FIG. 12 a shredder 1200 has four motors 431-434. Motor pairs 431, 432 have cutters turning in opposite directions to avoid a spinning torque on shroud 4000. The same applies to motor pairs 433, 434.

Handle guide 11L is for the left worker 4L, and handle guide 11R is for the right worker 4R.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A shredder comprising:
a shroud having a bottom surface suited to travel across a floor;
a motor mounted on a top surface of the shroud with a drive shaft facing downward;
said milling cutter mounted on the connection means so as to extend below the bottom surface of the shroud;
said shroud having a handle guide means functioning to allow an operator to move the shroud; and
said milling cutter having a plurality of peripheral blade means functioning to shred the floor forming debris such that the milling cutter drills down into the floor which allows the bottom surface of the shroud to travel across the floor as moved by the operator.

2. The shredder of claim 1, wherein the motor is a pneumatic motor powered by a hose which is connected to a remote compressor.

3. The shredder of claim 2, wherein the top surface of the shroud further comprises a vacuum port connected to a vacuum hose which removes the debris from under the shroud.

4. The shredder of claim 3, wherein the bottom surface of the shroud further comprises a concave groove under the vacuum port to collect debris.

5. The shredder of claim 4, wherein the shroud further comprises a peripheral vertical wall and a rear portion of the vertical wall supports a curtain which traps the debris.

6. The shredder of claim 1, wherein the shroud further comprises a set of wheels to allow a rearward tilt of the shroud to provide a rolling transport means for the shredder.

7. The shredder of claim 1, wherein the bottom surface of the shroud further comprises a front edge that is curved upward to allow the shroud to travel over bumps in the floor.

8. The shredder of claim 1, wherein the motor further comprises an emergency cutoff tether affixable to the operator.

9. The shredder of claim 1, wherein the handle guide means further comprises an “ON” switch which requires the operator to activate in order to power the motor.

10. The shredder of claim 1, wherein the shroud is round, and the motor is mounted in a center point of the top of the shroud.

11. The shredder of claim 1, wherein the milling cutter further comprises a plurality of coolant channels fed by a coolant entry port which is connected to a coolant fluid supply.

12. The shredder of claim 1, wherein the shroud further comprises a coolant entry port connected to a coolant source which propels a coolant fluid toward the milling cutter.

13. The shredder of claim 11, wherein the connection means further comprises a coolant entry port which connects to a channel in the connection means which feeds the coolant entry port of the milling cutter.

14. The shedder of claim 3, wherein the vacuum hose is connected to a remote vacuum having a debris container.

15. A shredder comprising:
a shroud having a bottom surface suited to travel across a floor;
a first motor and a second motor mounted on a top surface of the shroud, each motor having a drive shaft facing downward;
a connection means attached to each drive shaft functioning to turn its respective milling cutter;
each milling cutter mounted on the connection means so as to extend below the bottom surface of the shroud;
said shroud having a handle guide means functioning to allow an operator to move the shroud; and
each milling cutter having a plurality of peripheral blade means functioning to shred the floor forming debris such that each milling cutter drills down into the floor which allows the bottom surface of the shroud to travel across the floor as moved by the operator.

16. The shredder of claim 15, wherein each motor is a pneumatic motor powered by a hose which is connected to a remote compressor, and the shroud further comprises a vacuum exhaust port to remove the debris via a remote vacuum and a connecting hose.

17. A shredder comprising:
a shroud having a bottom surface suited to travel across a floor;
a first motor and a transmission means mounted on the shroud, wherein the transmission means functions to drive two milling cutters in opposite directions;
each milling cutter mounted on the transmission means so as to extend below the bottom surface of the shroud;
said shroud having a handle guide means functioning to allow an operator to move the shroud; and
each milling cutter having a plurality of peripheral blade means functioning to shred the floor forming debris such that each milling cutter drills down into the floor which allows the bottom surface of the shroud to travel across the floor as moved by the operator.

18. The shredder of claim 17, wherein the motor is a pneumatic motor powered by a hose which is connected to a remote compressor, and the shroud further comprises a vacuum exhaust port to remove the debris via a remote vacuum and a connecting hose.

19. A shredder comprising:
a shroud having a bottom surface suited to travel across a floor and sized to allow a first operator to walk next to a second operator to control the shroud using a handle guide means for each operator;
a plurality of motors located on the shroud in front of the handle guide means for the first operator, and a plurality of motors located on the shroud in front of the handle guide means for the second operator;
wherein each motor has a milling cutter connected to its drive shaft so that each milling cutter extends below the bottom surface of the shroud; and
each milling cutter having a plurality of peripheral blade means functioning to shred the floor forming debris such that each milling cutter drills down into the floor which allows shroud to travel across the floor as moved by the operators.

20. The shredder of claim 19, wherein each motor is a pneumatic motor powered by a hose which is connected to a remote compressor, and the shroud further comprises a vacuum exhaust port to remove the debris via a remote vacuum and a connecting hose.
